(19) United States
(12) Patent Application Publication
(10) Pub. No.: US 2011/0031038 A1
(43) Pub. Date: Feb. 10, 2011

(54) METHOD AND DEVICE FOR INDICATING DOSES IN A DRUG DELIVERY SYSTEM

(75) Inventor: Paul PAGE, Westminster, CO (US)

Correspondence Address: REILLY INTELLECTUAL PROPERTY LAW FIRM, 1325 East 16th Avenue, DENVER, CO, 80218, US

(73) Assignee: SAGATULO, INC., Broomfield, CO (US)

(21) Appl. No.: 12/853,158

(22) Filed: Aug. 9, 2010

Related U.S. Application Data
(60) Provisional application No. 61/232,312, filed on Aug. 7, 2009.

(51) Int. Cl. G01G 19/00; G01G 21/22

(52) U.S. Cl. 177/1; 177/25.11

(57) ABSTRACT

A method and apparatus for measuring and displaying the remaining doses in a metered-dose inhaler is made up of a housing having a weigh scale and load cell, a display screen in hinged relation to the housing, and a calculator associated with the load cell for subtracting the measured weight of the inhaler, after one or more doses have been expelled from the inhaler, from its original gross weight to determine the net weight of the contents of the inhaler, and dividing the net weight of the contents by the per dose weight followed by displaying the resultant number of doses remaining in the inhaler on the display screen.

The present application is a utility conversion of provisional patent application Ser. No. 61/232,312 filed 7 Aug. 2009, for DOSES IN A DRUG DELIVERY SYSTEM, by Paul Page and herein incorporated by reference.

The following is a method and device for determining the drug levels in a container and more specifically a method and device for indicating the doses in a drug delivery system through a visual digital display scale.

### BACKGROUND

Pressurized containers for drug delivery are well known in the prior art. A metered-dose inhaler (MDI) is a pressurized self-propelled aerosol device that uses propellants to administer a therapeutic agent. MDI's are the most commonly used drug delivery systems for treating allergies, asthma, chronic obstructive pulmonary disease (COPD), and other respiratory diseases. MDI's provide delivery of a specific amount of medication to the nasal passages or lungs, usually by supplying a short burst of aerosolized medicine that is inhaled orally or nasally by the patient. Approximately 500 million MDI devices are manufactured worldwide each year.

A metered-dose inhaler consists of 2 major components: a canister and an actuator. The canister itself is typically an aluminum container including a metering dose valve with an actuating stem. The formulation resides within the canister and is made up of drug formulations, a liquefied gas propellant and in many cases, a stabilizing excipient. The actuator contains the mating discharge nozzle and generally includes a dust cap to prevent contamination.

Once assembled the patient then uses the inhaler by pressing down on the top of the canister, with their thumb supporting the lower portion of the actuator. Actuation of the device releases a single metered dose of liquid propellant that contains the medication. Breakup of the volatile propellant into droplets, followed by rapid evaporation of these droplets, results in an aerosol consisting of micrometer-sized medication particles that are then breathed into the lungs. On actuation (i.e., the canister being triggered to deliver a dose), a fine atomized spray occurs over 100-200 milliseconds to deliver the dose. The delivered dose is dependent on the product used. Most particles have high inertia, and most of the output at the orifice of the actuation consists of droplets that are large (25 microns) and have high velocities (30 m/s).

One example of a disease in which MDI's are used frequently is asthma. Asthma is a chronic inflammation of the bronchial tubes that causes swelling and narrowing of the airways. Approximately 7 percent of all children are affected by asthma. In addition, 16 million adults suffer from this disease within the United States and Canada, as well. Over the past 20 years, the number of new cases and the yearly rate of hospitalization for asthma have increased about 30 percent. Even with advances in treatment, asthma deaths among young people have more than doubled. There are several benefits to delivering asthma medication with pressurized metered-dose inhalers. Included are effectiveness, economy and convenience. For most patients, MDI's are a critical part of their asthma management. Unfortunately, knowing when the device is empty of medication is extremely difficult for patients to determine. It is not uncommon for patients to throw away their inhaler when there is still medication in the canister. A more threatening condition is to continue using the MDI after the medication has been mostly or completely depleted.

Knowing when a metered-dose inhaler is empty is a long-standing problem. MDI's are the only medication delivery system approved by the United States Food and Drug Administration (FDA). Unfortunately, current devices do not allow patients to reliably know whether they have an adequate, effective amount of medication remaining in the canister. A variety of methods have been adopted by patients to overcome this limitation, including assessing the strength of the puff by squirting it into the air, shaking the inhaler to feel for the amount of remaining liquid in the device, or floating the canister in water to check for the angled position of the inhaler. None of these methods are reliable enough to recommend. The most accurate method has been to keep track of the number of actuations used and discard the device when the allotted number of doses (as printed on the box and/or inhaler) has been used up. Unfortunately, log files are inconvenient and probably impractical with a device that may be used sporadically or over an extended period of time.

In March 2003, the FDA issued Guidance on the “Integration of Dose-Counting Mechanisms into MDI Drug Products” stating that either numeric dose-counters or indicator mechanisms (color coding) were to be integrated into MDI devices. The Guidance was targeted only at new products in development and those intended for the US market. The counter or indicator mechanism had to form an integrated part of the inhaler (not an add-on) and be designed so as to count downwards to zero, enabling patients to know when the device was approaching the end of its life.

Mechanical “counting” type mechanisms attached directly to the MDI can be an imperfect method for tracking medication use. The drug formula used in the MDI can be subject to “clogging” the dispenser resulting in a “partial” dose of the intended medicine. A counter depicts a “full” dose used, even when the MDI expels a partial dose. This design flaw can be misrepresentative of the actual amount of medication received by the patient. A patient may believe they are meeting their physician's recommendation for daily prescribed doses, but in fact could only be receiving partial treatment. “Misfires” can also result in the patient believing that they are receiving medicine by depending on the accuracy of the mechanical counters. It is not uncommon for more than one patient in the same household to use the same type or brand of MDI medicine. Therefore, it is easy to accidentally pick up an MDI that has the same medicine as the patients but belongs to another family member. The use of borrowed MDI will treat the patient's symptoms but can lead to the miscounting of doses used.

There is a need for a stand-alone device that will measure the doses remaining in a drug delivery system by sensing the weight of medication remaining in the canister that is accurate, easy to use and can be used in conjunction with different brands of inhalers and medication. The current device measures the medication dosage remaining in a canister and has a scale unit having a weigh pan housed within a base member, a power source, a display unit associated with the scale unit, and a method for converting weight data from the scale unit to dosage information to be displayed on the display unit. The above and other features will become more readily appreciated and understood from a consideration of the following detailed description of different embodiments when taken together with the accompanying drawings in which:

### DRAWINGS

FIG. 1 is a front perspective view of a form of measuring device shown with a metered dose inhaler;

FIG. 2 is side view of a display of the device of FIG. 1;

FIG. 3 is an exploded view of the measuring device of FIG. 1;

FIG. 4 is a front perspective view of an alternate form of display on a measuring device;

FIG. 5 is a front perspective view of an alternate form of display on a measuring device;

FIG. 6 is front perspective view of an alternate form of measuring device shown without a data card;

FIG. 7 is a side view of the form of device shown in FIG. 6;

FIG. 8 is an opposite side view of the form of device shown in FIG. 6;

FIG. 9 is front perspective view of the alternate form of measuring device shown in FIG. 6 with a data card;

FIG. 10 is an exploded view of the measuring device of FIG. 9;

FIG. 11 is a top plan view of a display of an alternate form of measuring device;

FIG. 12 is a bottom plan view of the display of FIG. 6;

FIG. 13 is a block diagram of a method of determining remaining doses of medication in a canister;

FIG. 14 is a block diagram of an alternate method of determining remaining doses of medication in a canister;

FIG. 15 is a flow chart illustrating the logic used in the device button selections;

FIG. 16 is a flow chart illustrating the logic used in the ON/TARE function;

FIG. 17 is a flow chart illustrating the logic used in the OFF function;

FIG. 18 is a flow chart illustrating the logic used in the Brand Select function;

FIG. 19 is a flow chart of the logic used in the Data Card Installed function;

FIG. 20 is a flow chart of the logic used in the Data Card Removed function;

FIG. 21 is a flow chart of the logic used in the Weight Conversion function;

FIG. 22 is a flow chart of the logic used in the USB Connected function;

FIG. 23 is a flow chart of the logic used in the Object Removed function;

FIG. 24 is a flow chart of the logic used in the USB Connected to the Initiating Device function;

FIG. 25 is a flow chart of the logic used in the Brand Lot Validation function;

FIG. 26 is a flow chart of the logic used in the Generic Brand Program function;

FIG. 27 is a flow chart of the logic used in the Website Application function; and

FIG. 28 is a flow diagram of website, host and device relationship.

### DETAILED SUMMARY

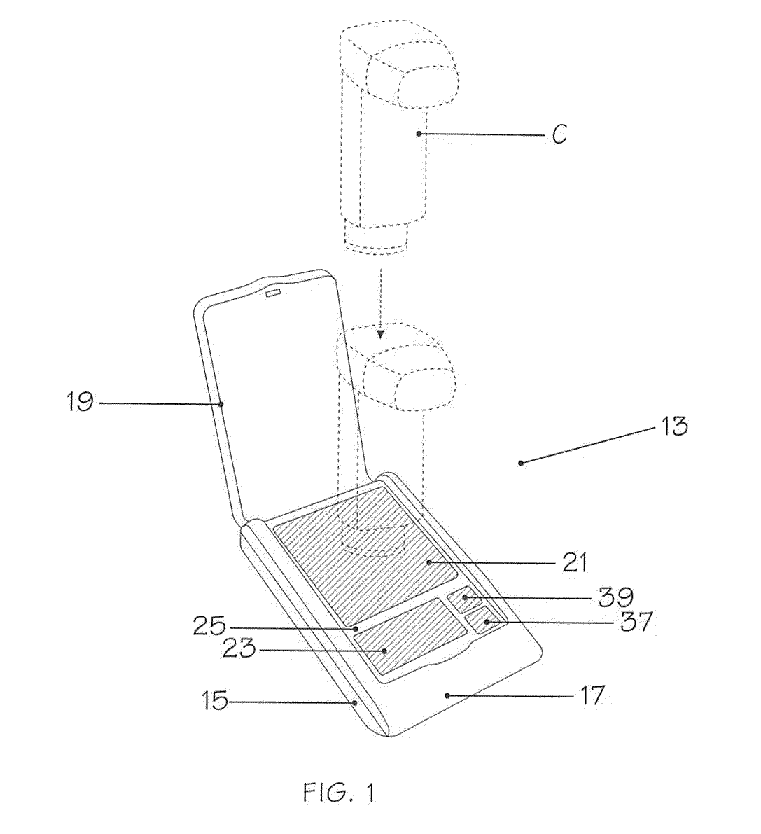

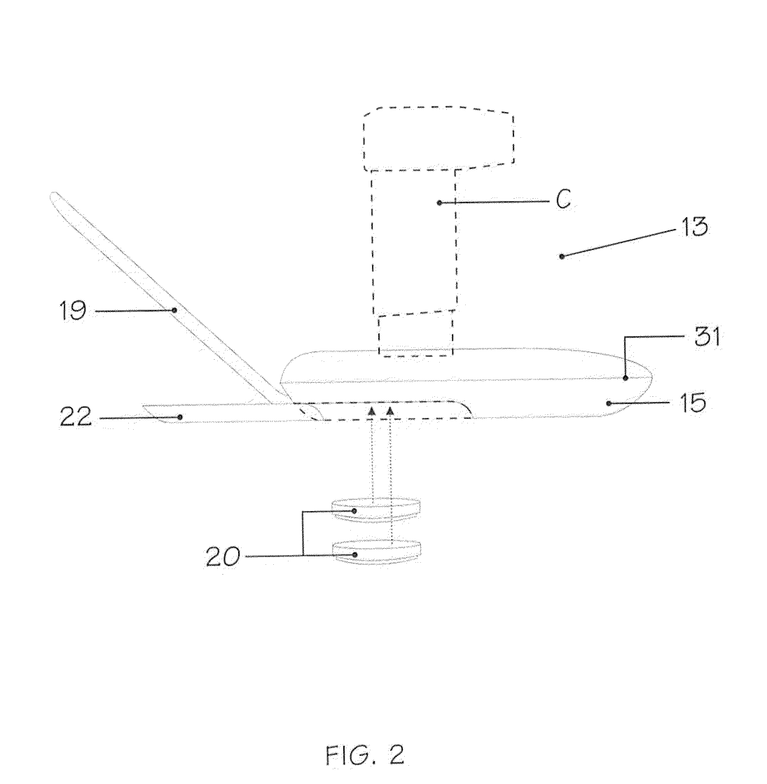

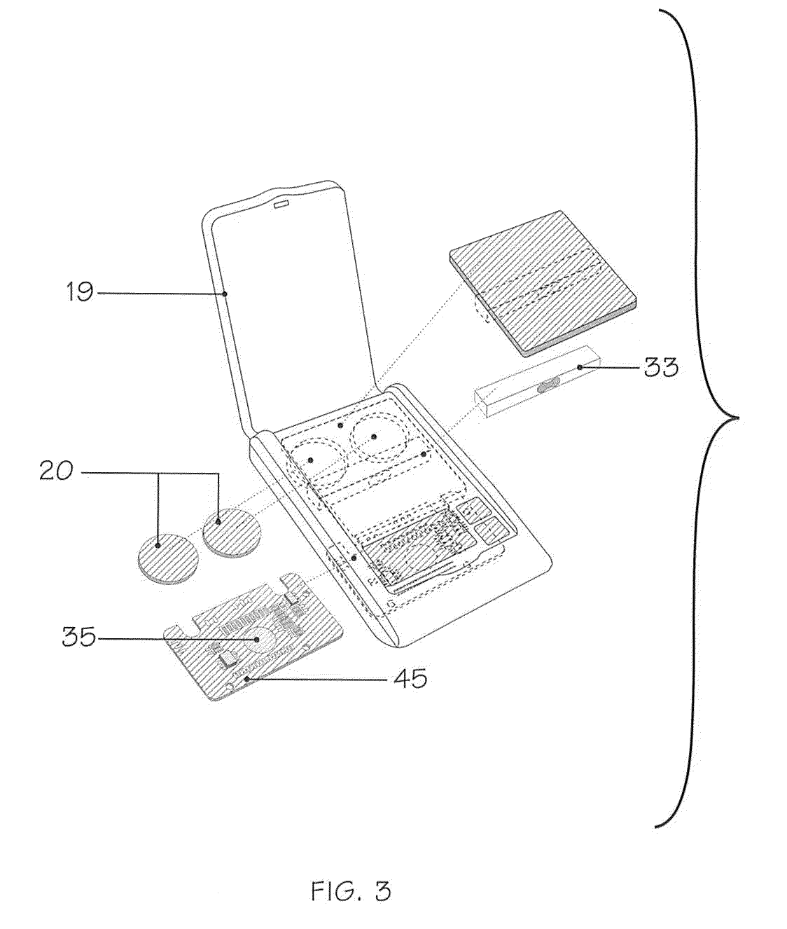

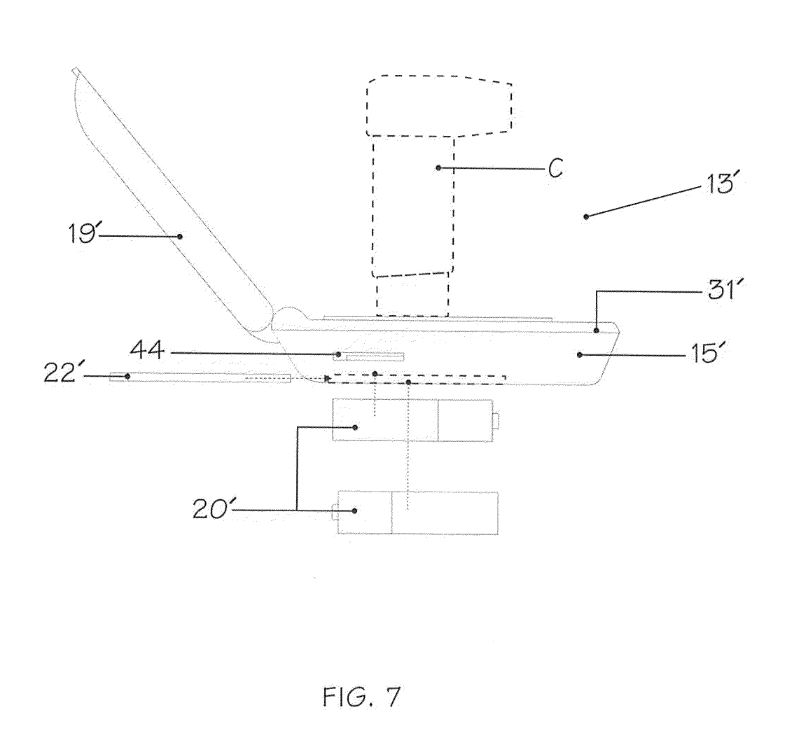

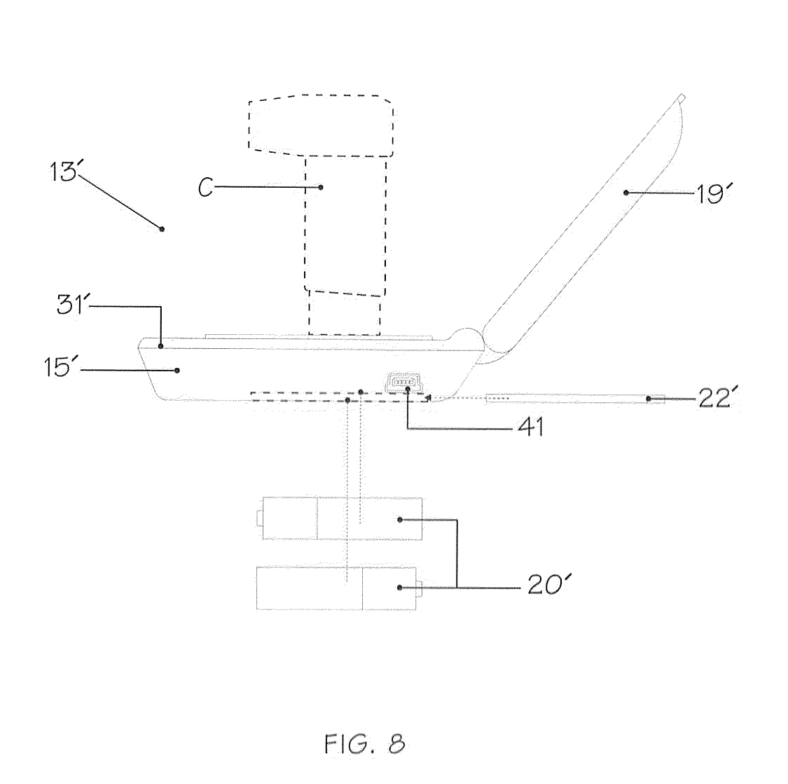

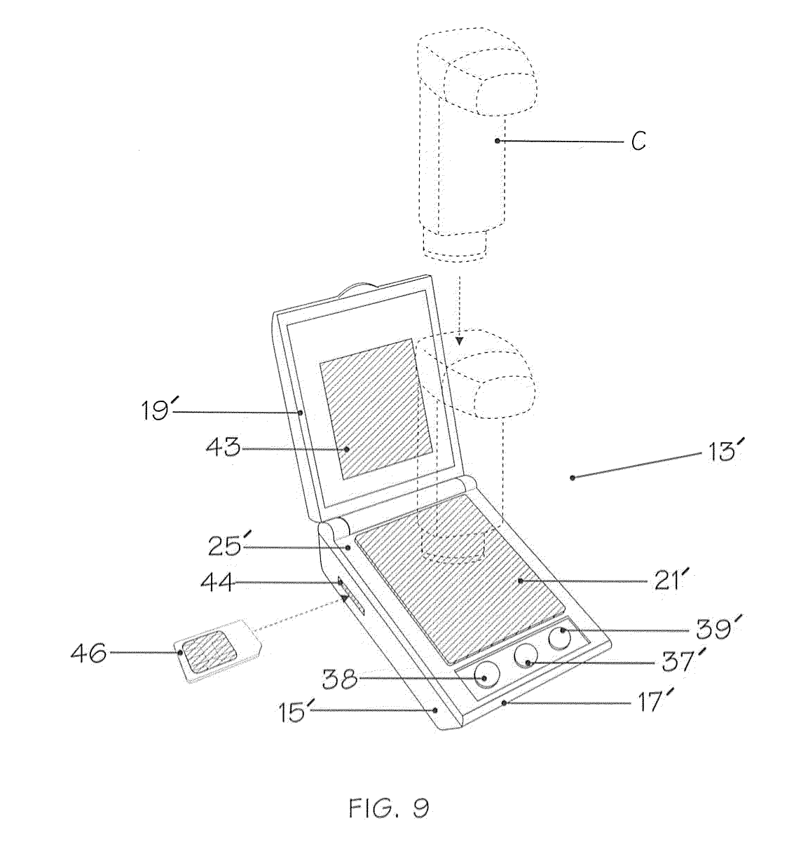

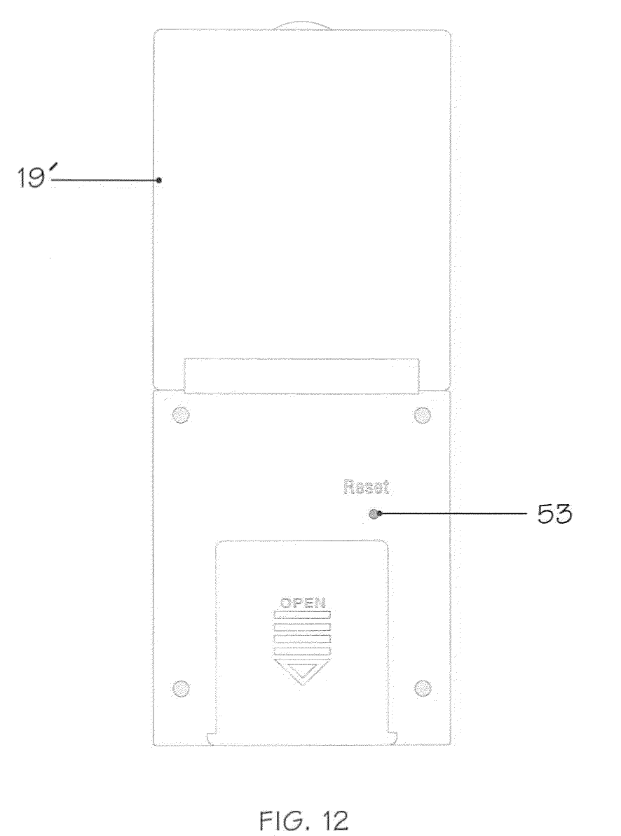

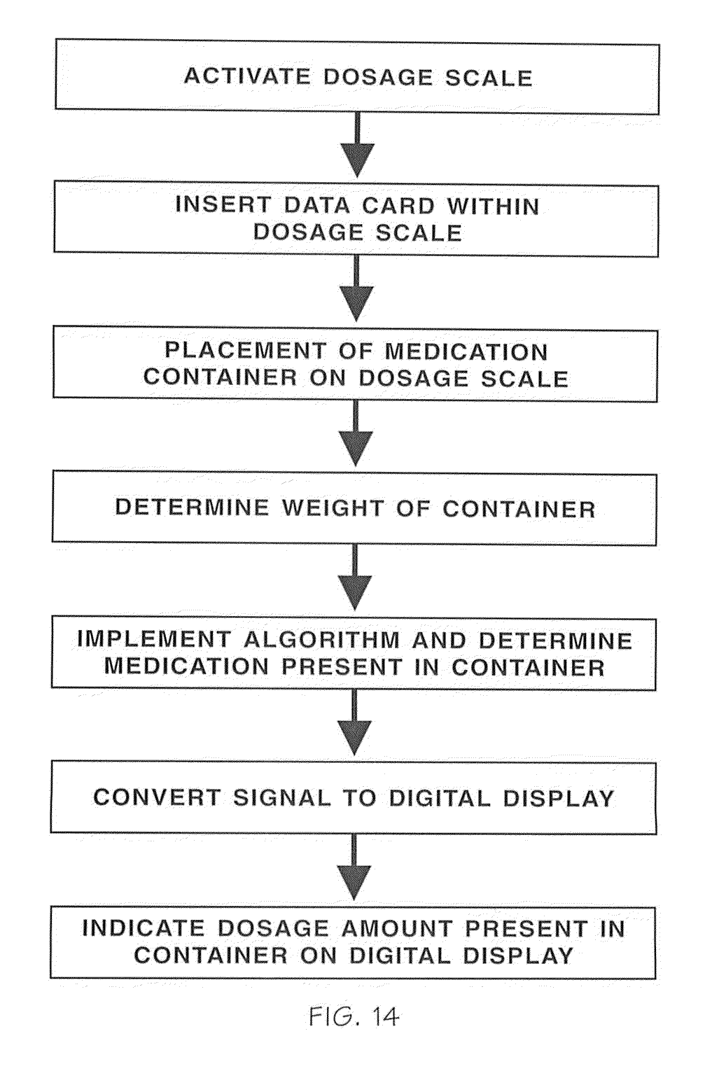

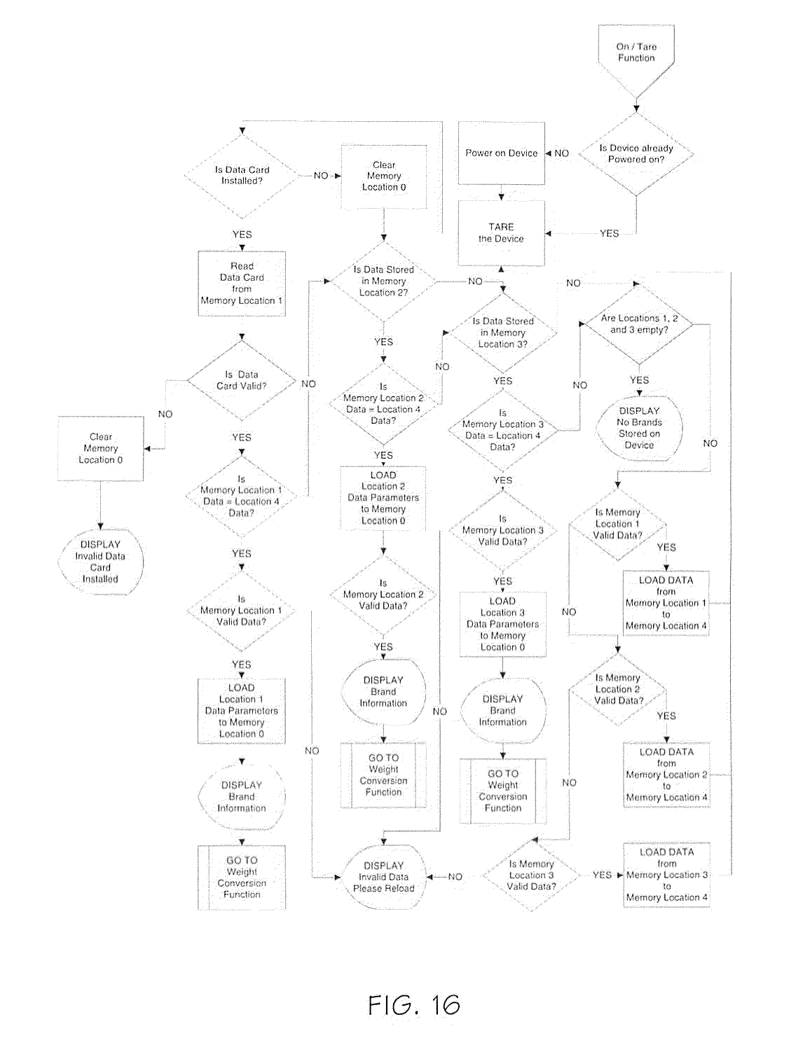

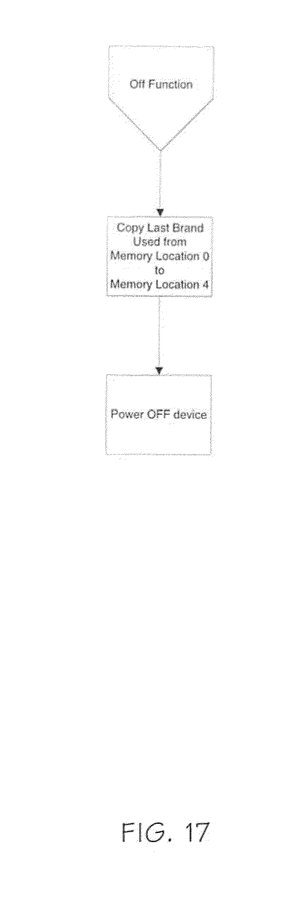

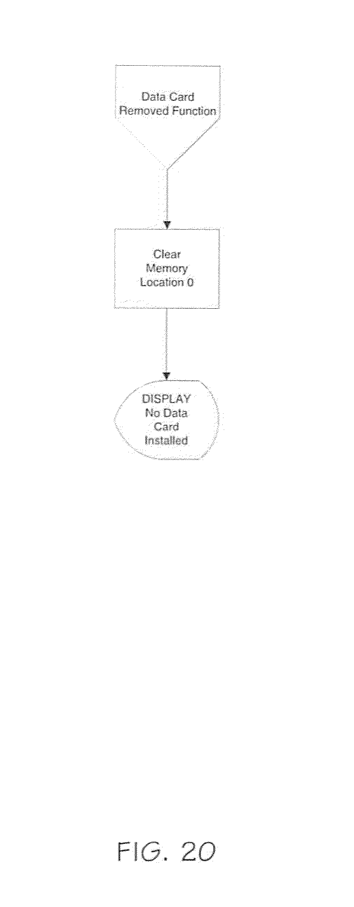

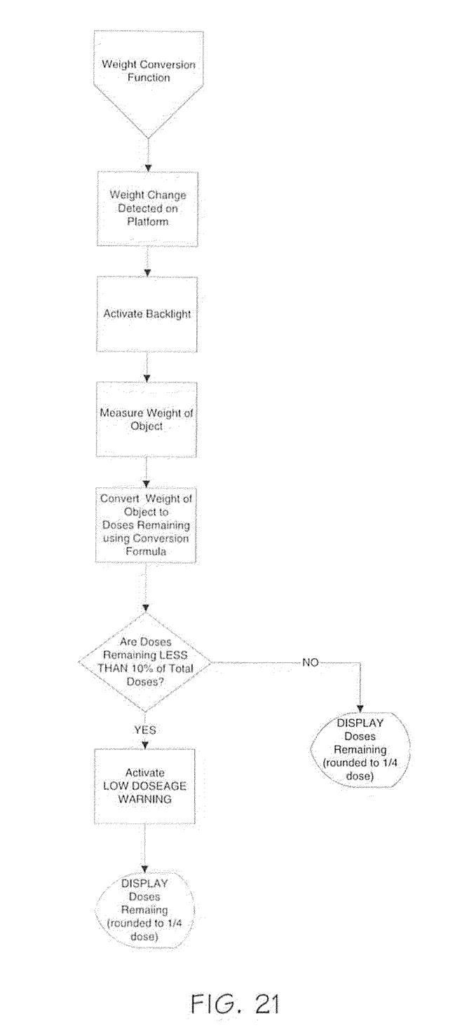

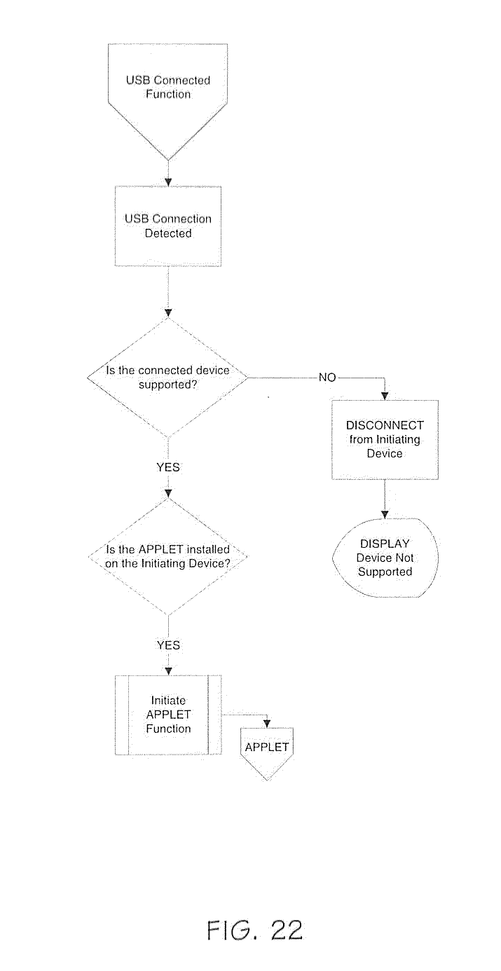

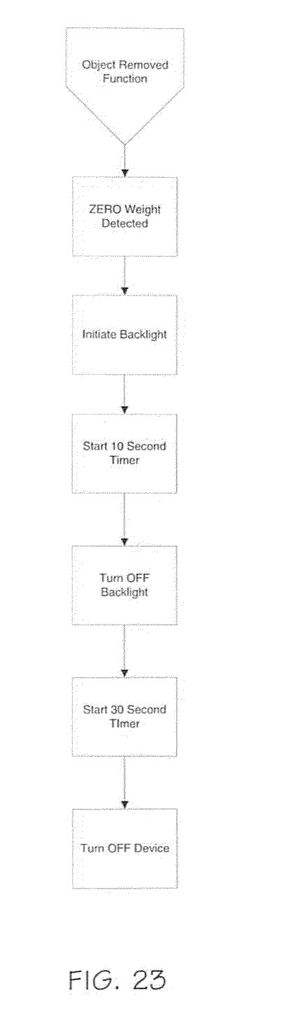

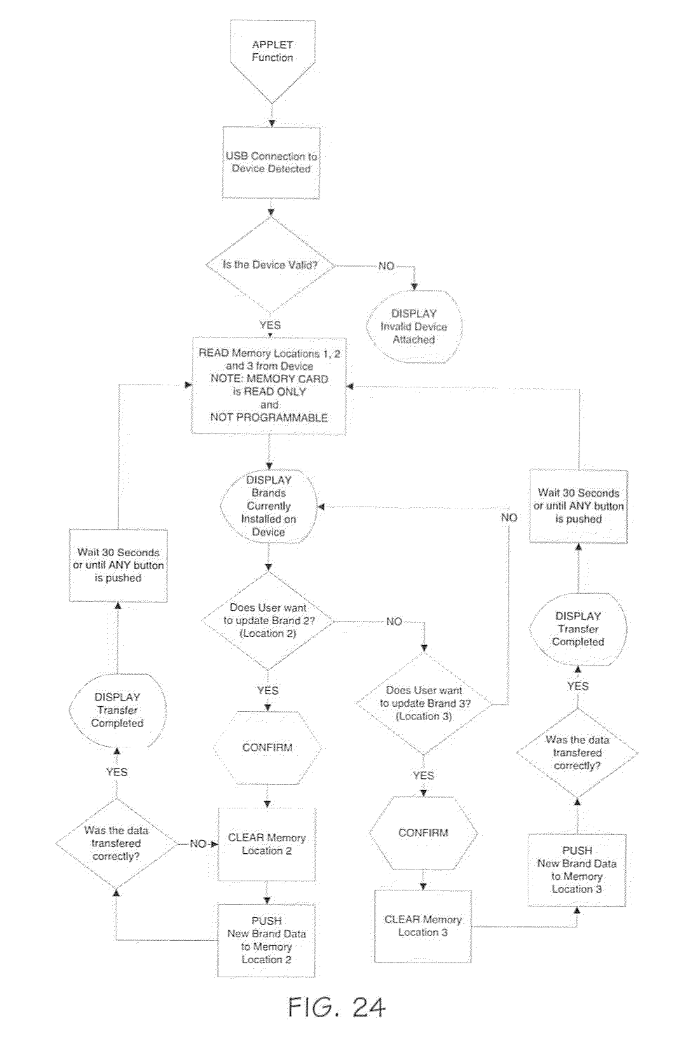

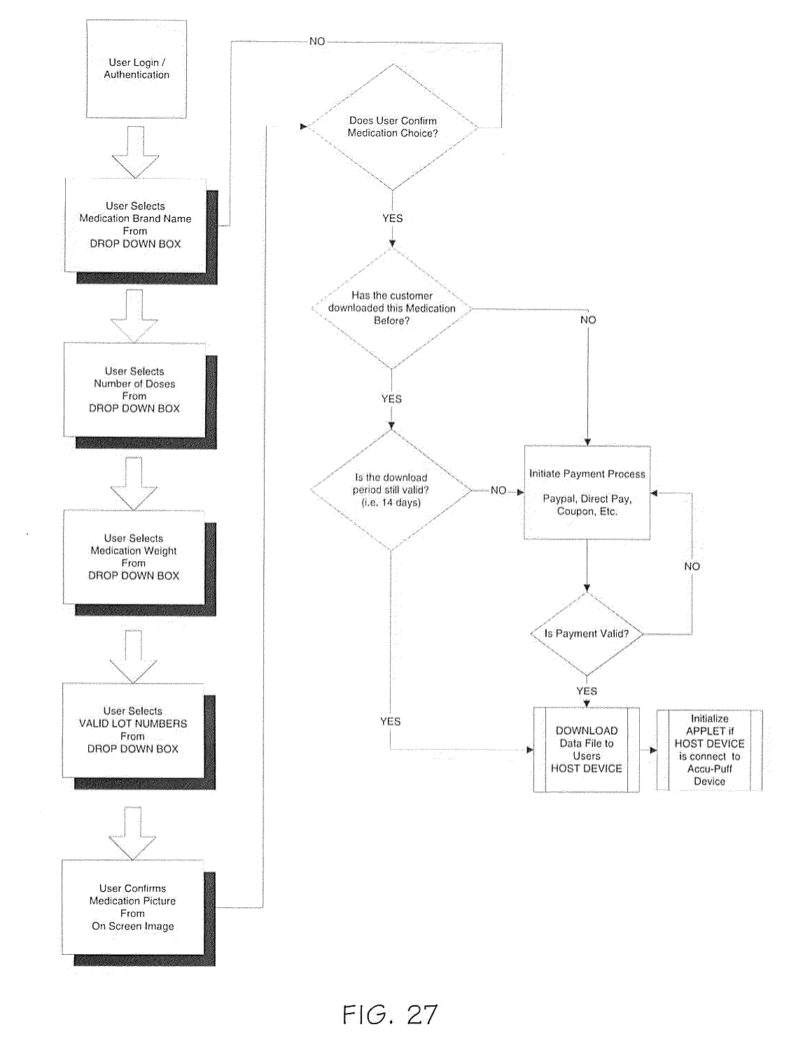

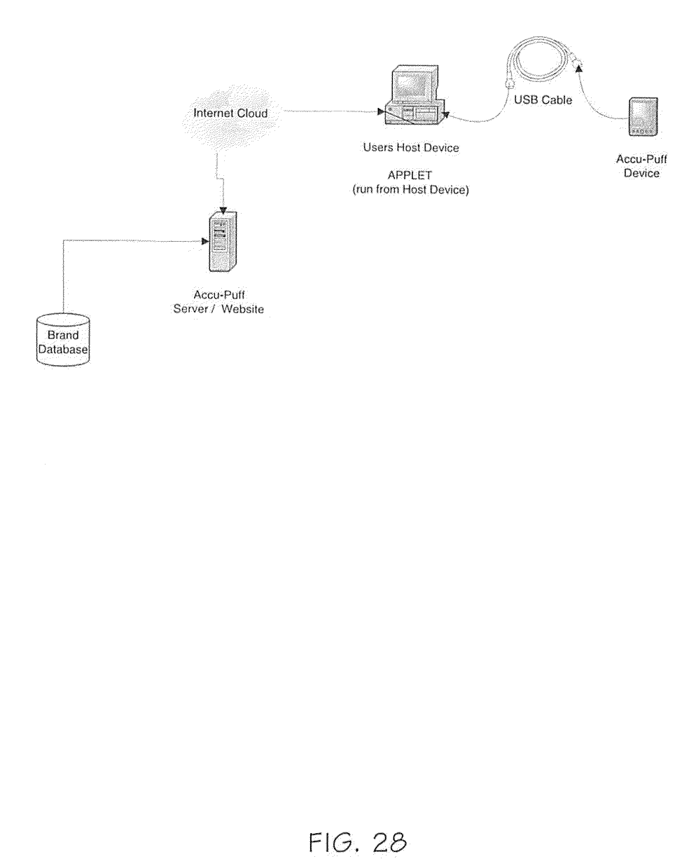

Shown in FIGS. 1 through 28 are embodiments and methods of a non-integrated measuring and display device for determining medication dosage levels remaining in a container C; the device may be used to weigh the amount of substance, namely; gas, solid or liquid medicament remaining in a container and converting such data to a useable form, such as the actuations or doses of medication remaining in the container. The container C includes but is not limited to inhalers such as MDI's, nasal medicament dispensers and any other form of therapeutic compound or medicament dispenser that is capable of being placed on an independent scale unit. The measuring device, as shown in FIGS. 1-3, comprises a scale unit 13 having a base plate 15, a cover plate 17 and a recloseable lid member 19. A weigh scale pan 21 is housed within the base plate 15 and the base plate 15 also houses at least one battery 20 including a slide-in panel 22, providing electrical power to the scale unit 13. The base plate 15 and cover plate 17 are joined along a common edge 31 and contain load cells 33 which are well known in the prior art. The load cell technology includes a strain gauge that is caused to deform in response to the force of weight of a container C placed on the weigh scale pan 21. The change in resistance or deformation is then converted to an electrical analog signal which is run through an analog to digital converter and then passes through a microprocessor 35 that ‘translates’ the data. The microprocessor is designed to convert the data to a desired digital display. The method of conversion will be discussed in more detail at a later point.

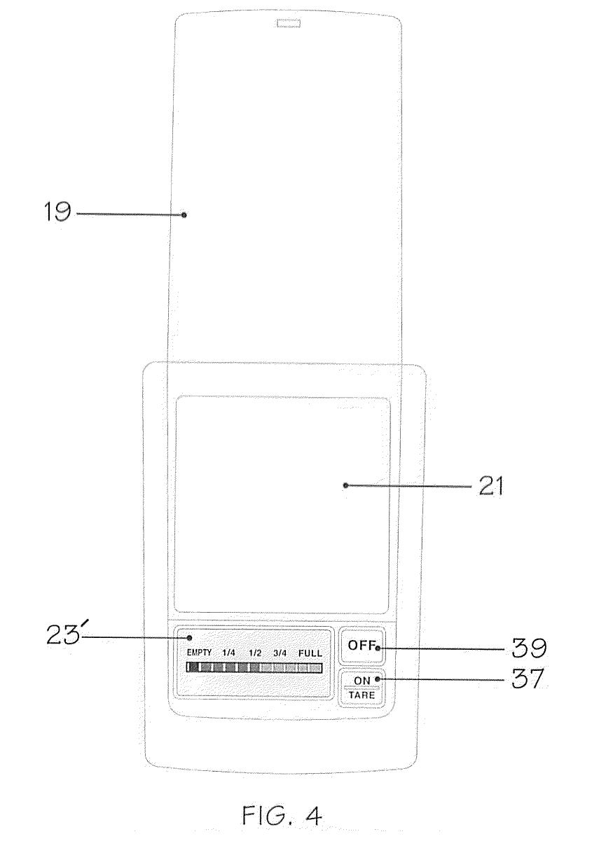

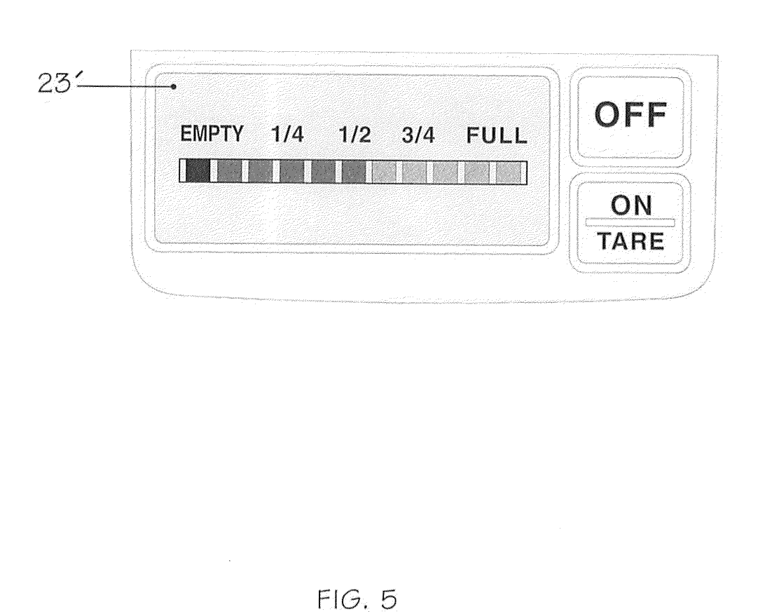

The cover plate 17 has a multi-function keypad 25 that includes an ON/TARE button 37 and an OFF button 39 although other forms of display and command prompts may be used without departing from the scope of the device and method. The scale unit 13 also includes a display portion 23. The display portion 23 is typically an LCD display capable of displaying numeric, pictoral as well as alphabetic information. As shown in FIG. 5, the display portion 23 indicates the dosages remaining in a measuring device. FIG. 4 demonstrates a display indicating fractional quantity of dosages remaining in an MDI. The display may also show the dosages used or a visual scale of color coded reference. For example, more than 50% of the doses remaining result in a green LED visual indicator; between 50% and 10% of the doses remaining result in a yellow visual indicator; less than 10% of the doses remaining results in a red indicator and 0 doses remaining results in a flashing red visual indicator. The color code is established to identify or signify the measured level of doses of medication remaining in a dispensing canister. A further form of display is a gasoline gauge type of display. Another form of display includes an audible alert to alert the user to the balance remaining in the canister as well as a numeric output. The various forms of display are described for illustration purposes only and are not meant to be limiting. The display portion 23 may be backlit with an LED light for ease of viewing.

The device 13 has been programmed or calibrated based on the tare weight or unladen weight of the MDI which includes the mass or weight of the canister and metering valve plus the mass or weight of the actuator including the mouthpiece and dust cover. Any form of canister or delivery device may be used with the tare weight that has been pre-calculated. When an MDI, for example, is placed on the weigh pan 21, the system as described above, weighs the MDI including the medication contained within the canister, measured in grains. The microprocessor 35, based on the programming, subtracts the tare weight of the MDI to calculate the number of grains present in the canister. The amount calculated is then translated into the number of doses remaining or available in the canister. The display system 23 is adapted to convey information to the user regarding dosages as described above.

The microprocessor programming is based upon entry of specified values based upon predetermined information. For example and not by way of limitation, in medications typically dispensed through a meter dose inhaler, the amount of medication contained within these canisters is preset with a varied total number of maximum doses or actuations (i.e. approximately 50, 100, 200, etc doses). This value is represented by “A”.

The weight of each dose expelled under “pressurized metered dose conditions” is calculated and designated as “B” providing a consistent value for the formula.

The maximum mass or weight of the canister which includes a usable medicine or formulation made up of a drug, a liquefied gas propellant and in many cases, a stabilizing excipient which remains constant under varying thermal and or atmospheric conditions, and the metering valve, actuator, mouthpiece and dustcover is designated as “C”.

The mass or weight of the canister including the propellant and metering valve plus the mass or weight of the actuator including the mouthpiece and dust cover, also referred to as the tare weight are designated as “D”.

The gross measured weight (at any given time) including the canister, propellant, metering valve, actuator, mouthpiece, dustcover and drug formulation are designated as “T”.

Based on the information above, the formula is applied as follows:

(T)=Measured Weight

(U)=(C)−(T)

(Used Weight)=(Maximum Weight) minus (Measured Weight)

(V)=(U)/(B)

(Doses Used)=(Used Weight) divided by (Per Dose Weight)

(W)=(A)−(V)

(Doses Remaining)=(Maximum Doses) minus (Doses Used)

Simplified: W=A−[(U/B)]

(Doses Remaining)=(Maximum Doses)−[(Used Weight)/(Per Dose Weight)]

For example:

A=200 maximum doses
B=1.5 grains (per dose weight)
C=400 grains (maximum weight)
D=100 grains (tare weight)
T=385 grains (measured gross weight)
U=15 grains (used weight)
V=10 doses used
W=(200−10)=190 doses remaining.

A tare weight for a selected brand of medicament has been calculated and is preset into the scale. The number of maximum doses, the maximum weight and the per dose weight of the selected brand are also preset into the scale. Each inhalation of the medication would reduce the weight of the inhaler by approximately 1.5 grains per dose. Once the user places the canister on the scale 13, the measured gross weight is entered and the scale will show the number of doses remaining.

To confirm this, an initial study was conducted where labeled Metered Dose Inhalers were used in conjunction with their weights recorded after each use. The study showed the feasibility of accurately measuring the doses used and therefore doses remaining with a margin of error of only +/−5%. A second study was conducted in which the weights of 2 canisters were measured using a calibrated digital scale to record the actual results of calculated and expected measurements of a Metered Dose Inhaler. The results showed that the calculated expectations per dose were 1.134 grains. The measured results were 1.136 grains with a difference of only 0.002 grains per dose or less than 0.001% error.

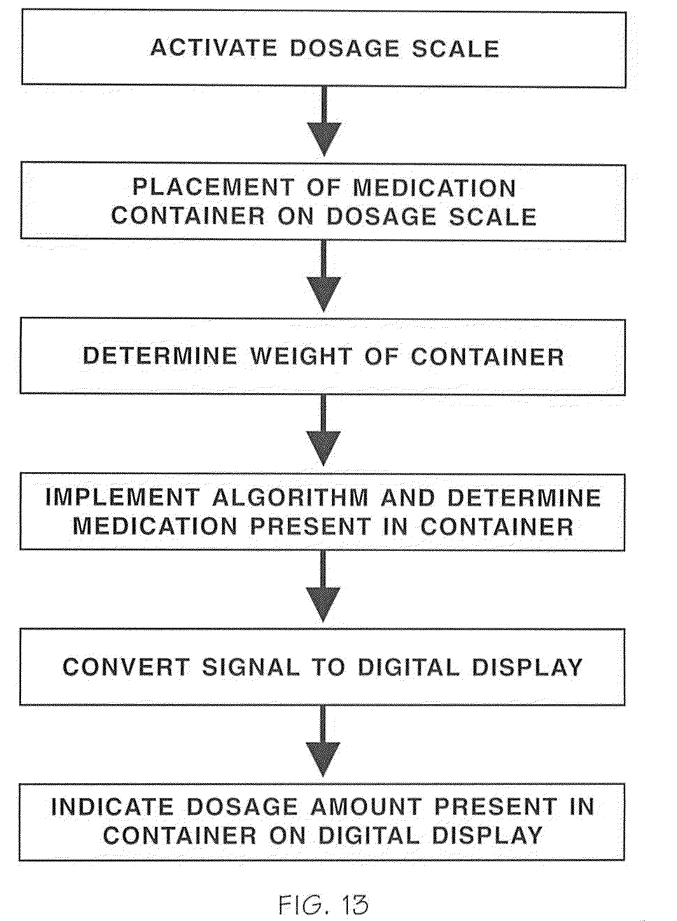

In operation, a user simply presses the ON/TARE button 37 to activate the dosage scale 13. The ON/TARE button is used to turn on the device and zero balance the weighing system. Upon depressing the button, the unit performs an automatic power on self test, energizing the backlight LCD. During the self test, the unit performs a zero weight calibration, ensuring a “zero starting weight” prior to measuring the MDI. The TARE function is executed by pressing the ON/TARE button at any time while the unit is powered on. This function minimizes the possibility of erroneous readings and improves accuracy. A preselected MDI or any other type of medicament dispenser C that corresponds to the device 13, is placed on the weigh pan 21, as shown in FIG. 1. The actual used weight of the MDI is recorded and subtracted from the stored tare weight and gross weight of the MDI. The net weight of the contents of the MDI is then converted into the doses remaining in the MDI. The steps taken and logic used are set forth in FIG. 13.

More specifically, the device 13, in one form, is programmed to calculate the exact number of doses remaining of a particular medication. For example, the lid member 19 of the device 13 is opened up and the ON/TARE button 37 is pressed. Number ‘0’ will appear in the LCD display portion 23. A pre-selected MDI, such as, Combivent® will have an orange dust cap, for example, that matches the color on a portion or all of the device 13 but is not limited by the color combination. Once again, a color code is established to identify or signify matching of a particular brand of medication with an appropriate device. Any type of medication or manufacturer may be used without departing from the scope of the embodiments set forth herein. The measuring device may be a stand-alone device sold separately from an inhaler or sold in conjunction with an inhaler. The color coordination allows the user to verify that the proper MDI/medicine is in use with the proper corresponding device 13. For example and not by way of limitation, a Combivent® MDI is placed on the weigh pan 21 and the device measures the resistance present on the load cell 33, translates the electrical impulse and converts the result to a digital form that appears in the LCD display 23, such as the number of actuations or doses remaining in the canister.

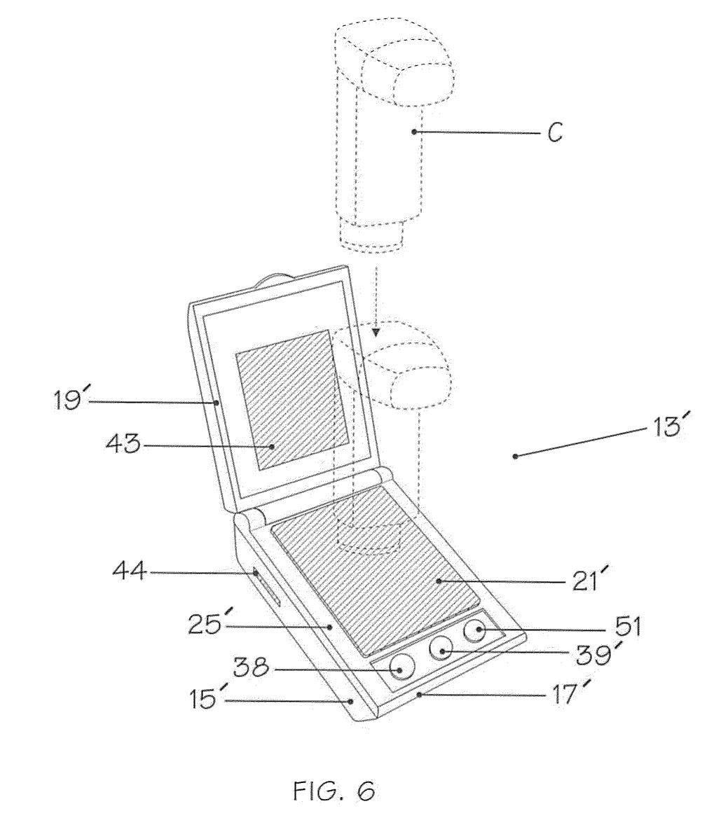

Additional forms of device allow for use of a number of different manufacturers of medications for MDI's on a single device as shown in FIGS. 6-11. The measuring device has a case with a flip top 19′, a smart data card 46 inserted into a smart data card port 44 used in conjunction with an LCD screen 43, an electronic scale 21′, an electronic BUS card with a USB port 41 and a battery power source 20′. The scale is configured to weigh specific inhalers from specific manufacturers. The calibration and datasets are uploaded through the USB port 41 or the Smart Data Card port 44. The USB port 41 is connected to a target computer to upload all of the calibration information along with user and medical information to the devices internal non-volatile memory.

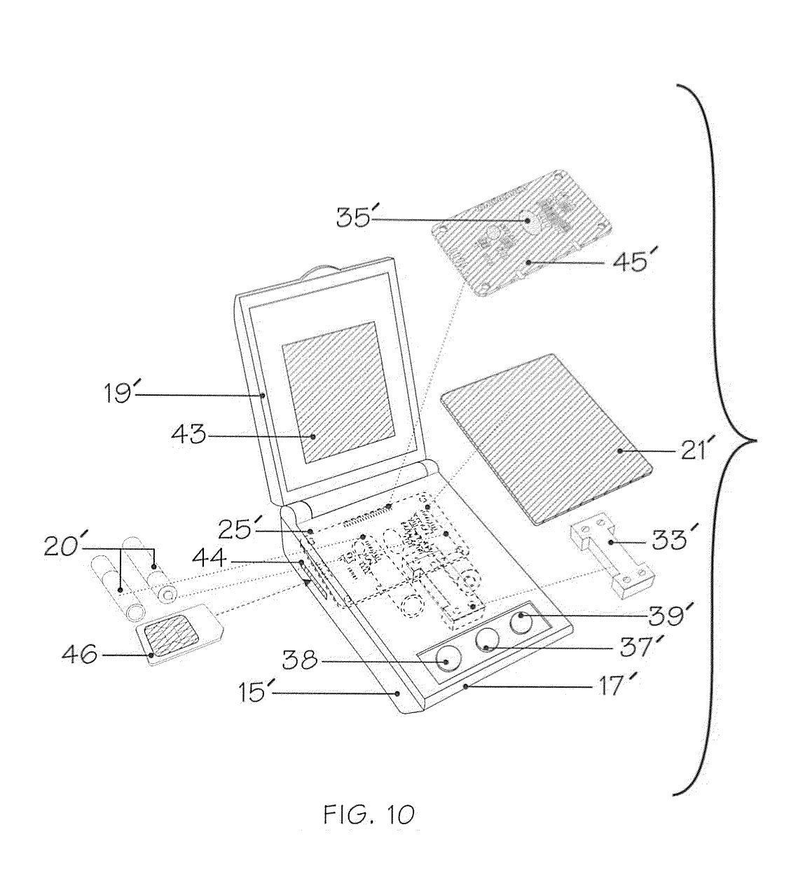

As shown in FIGS. 6 through 11, where like parts are correspondingly enumerated as above, an alternate form of device uses the same minimum data as the first method, i.e. MDI maximum and minimum weights, maximum number of doses and weight per dose, however each specific brand data is stored on the removable data card 46. The removable data card method allows multiple brands to be measured using a generic “doses remaining” scale but allowing unique data cards to be inserted as required by the brand of medicine being weighed. In operation, a user simply presses the ON/TARE button 38 to activate the dosage scale 13′. The ON/TARE button is used to turn on the device and zero balance the weighing system. Upon depressing the button, the unit performs an automatic power on self test, energizing the backlight LCD while displaying a Welcome/Trademark screen until the test is complete. Once the data card 46 is inserted into the data card port 44 of the base member 15′, the canister C is then placed on the weigh pan 21′. Each data card contains specific brand and canister information, creating pre-established tare weights as well as maximum doses. For example, but not by way of limitation, a Secure Memory Smart Card, manufactured by Smart Card World or the Amtel CryptoMemory card, may be used and programmed with specific data. A control unit 45′, including the microprocessor 35′ and shown in FIG. 10, is configured to read specified information from the data card 46, or such information can be provided to a memory chip on the control unit 45′ via an interface. The control unit 45′ reads and transfers the data to calculate the dosages remaining as set forth above. The OFF button 39′ performs the same function as previously set forth in the first embodiment.

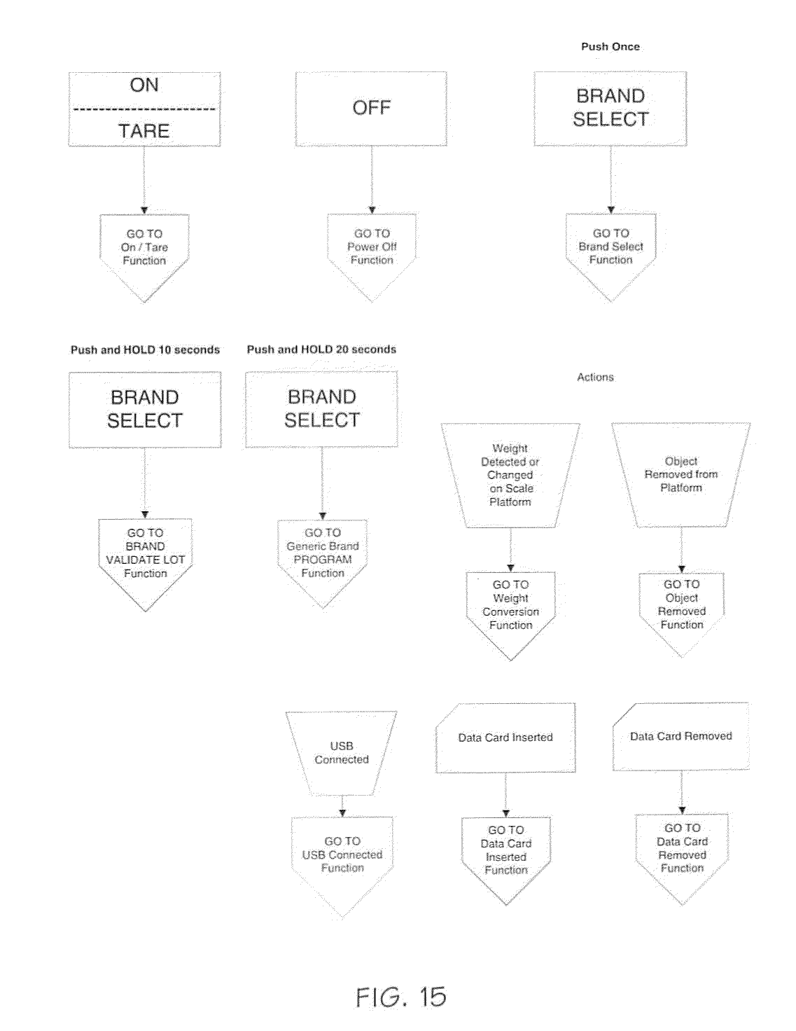

It should be noted that the device may also be set to calculate and display the dosages used or other such useful information. There are several methods for converting the measured data into a usable format that can be interpreted by the user. The first method consists of a fixed value device wherein a minimum set of values are used to compute the weighed data into the doses remaining output. The minimum data contained in the non-volatile memory within the scale circuitry consists of the MDI maximum weight, the MDI minimum weight (including tare weight), the maximum doses and the weight per individual dose. This method is used for specific medication brand measurements since virtually no two brands dispense doses in the exact same manner or dispense the exact same dose volume by weight. The logic used in this form of device is set forth in FIGS. 15, 16, and 17.

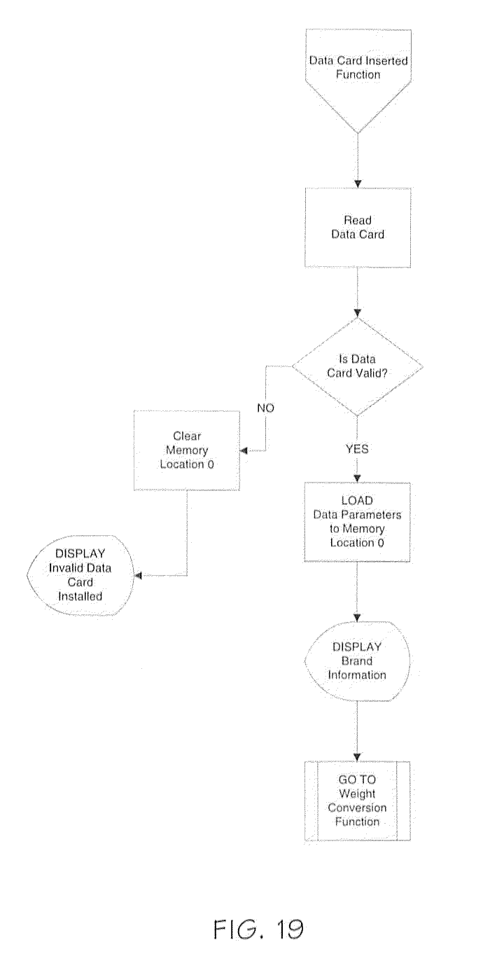

Another method uses the same minimum data as the first embodiment described, but the minimum data as well as any additional data can be loaded into an erasable/reprogrammable memory chip integrated on to the circuit board. The data interface, also built into the device circuitry, would allow the device through the use of a USB (universal serial bus) 41, USB Mini port, or similar connection, to interface to a personal computer or other electronic transfer device. Once the unit is connected to the data transfer device (i.e., personal computer) the minimum data is programmed into the scale circuitry and thus reprogrammed to accommodate multiple brands as described and shown in FIGS. 19, 20, 22 through 24, 27 and 28. The device may also be adapted to accommodate a serial port 41 connector such that all information may be transferred to and from the device to a computer for analysis and storage. A reset button 53 is used to restart the device in case of a malfunction. The reset button is located through a small hole on the bottom of the device and is clearly marked. The unit will power on automatically once the reset button has been depressed.

In the above described form of device, there are four types of data that can be transferred to or from the device and the application software, although there can be several data and operation sets for a given data type or operation. Typically the device pushes a connection signal through the USB port along with configuration and specification data. Once a connection has been completed, the application launches and can push data back to the device to configure it for the next type of medications. The device also has the ability to request data sets that may have become corrupted or missing from the set. Configuration and specification data can be transferred between the unit and the data transfer device using application software such as XML, PHP, Apache or any other software configurations for viewing and transfer. This could be a commercial product that functions similarly to the familiar File Transport Protocol (FTP) but with significant enhancements in performance, reliability and security. The software will consist of the application and daemon.

The interface may also be “hard” wired such as a USB (universal serial bus), serial, parallel, fiber optic cable, Network cable (i.e., category 5, 5e, 6, etc.). The transfer mechanism to load data to the device will be a USB cable tethered from the computer to the device. The functional transfer will be a central server that is reached via the Internet and secure login to download and modify user data sets. The central server will allow the user to download their configured data file to their target computer. The target computer will then configure the device via the USB port on the unit and any USB port on the target computer. Alternatively the device interface may utilize wireless standards such as 802.11, 802.11a, 802.11b, 802.11g, 802.11-2007, 802.11n, Bluetooth, Infrared, etc. to interface to the electronic transfer device. The application main server will provide a number of security mechanisms for the user to connect and initiate the data transfers. This application interface transfers all medication data to or from the device. The medication data consists of textual and numeric datasets describing the type of medication, starting weight, usage weight and dosage weights. There is also calibration data primarily for routine operations and diagnostics. There are eleven types of data values described for each medication brand: Brand name, Medicine Weight, Units, Maximum Doses, Action Type, Remaining dosages, Company registration data. The described data is broken into five data groups: Initial Display and Card Identification, Computational values, Reference data, and Display values.

Data values, and updates for the device are programmed into the device using a software program with or without a GUI (graphical user interface). The software program is then distributed via removable media such as floppy disk, CD Rom, smart media, flash drive or by a wireless connection, blue tooth, infrared or downloaded via the internet. Once installed and executed, the software program prompts the user to connect to the device using the same “hard” wired or wireless interfaces as described above and select whether they want to upload or download data to the device. Uploading causes the device to be reprogrammed to a different set of minimum data values. Downloading causes the device to export stored data for user analysis. The downloaded data which was stored within the device circuitry can be used to display the user history and usage patterns. This data may also be viewed on the onboard display to show textual and numeric datasets describing medication, daily, weekly, monthly dose usage as well as trends of usage, such as data, time of day and peak usage for historical analysis. Calibration data primarily for routine operations and diagnostics may also be included. Security mechanisms are also in place for use in initiating data transfers.

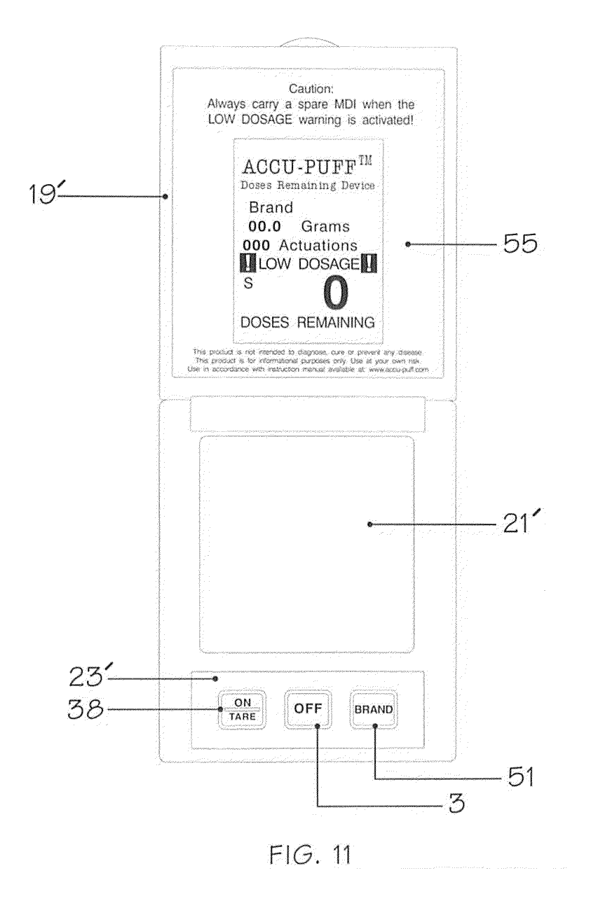

Still another form of device utilizes a display screen 55 that is in data communication with the control unit 45′ and the data card 46 as described above. The display screen 55, as shown in FIG. 11, is capable of displaying various details such as the information described above without limitation, but may also display user data history, medication compliance and any other type of useful information relating to the use of the medication canister. There are three types of data values specific for each different medication brand allowed. At least two brands may be stored in the unit's non-volatile memory and an additional brand may be selected by inserting a data storage card into the card reader on the device.

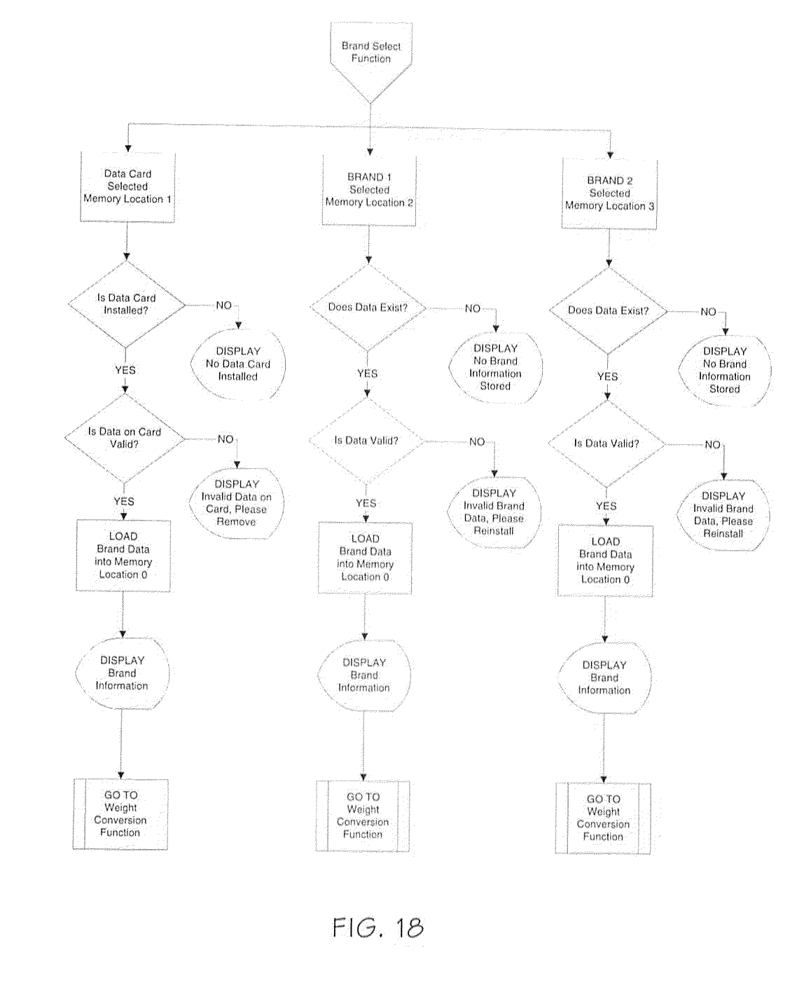

The Brand Select button 51 as shown in FIG. 11 is used to change which brand of medication is currently being measured on the device. The Brand Select button is a multi-function button allowing for the configuration of multiple medication brands or multiple users on the same device scale. The multi Brand functionality must be from a selection screen allowing the user to simply scroll a new brand by pressing the BRAND/SELECT button multiple times to scroll through preset configurations. As many as two menus might be configured to the device (Product Brand and User). The last brand of medication used is stored in the devices non volatile memory and is recalled when the unit is powered on. This allows the user to immediately use their most commonly measured MDI without having to navigate through the Brand Select screen each time the unit is initiated. Pressing the Brand Select button once will display a selection screen with all available brands stored on the device. One brand is stored on the SIM data card 46 and is displayed as the first brand available. If no SIM data card is installed in the SIM slot, a No Brand Stored message is displayed as the first brand choice. If an invalid SIM card is installed in the SIM slot, an Invalid Data Card message is displayed as the first brand choice. If additional MDI brands have been transferred to the device, they will be displayed as the 2nd and 3rd brand choices available. The Brand Select button is pressed until the > icon is next to the brand selected. Once the desired brand is noted with the icon, the brand button is released and the selected brand will be loaded as the current brand to be measured. This logic is shown in FIG. 18.

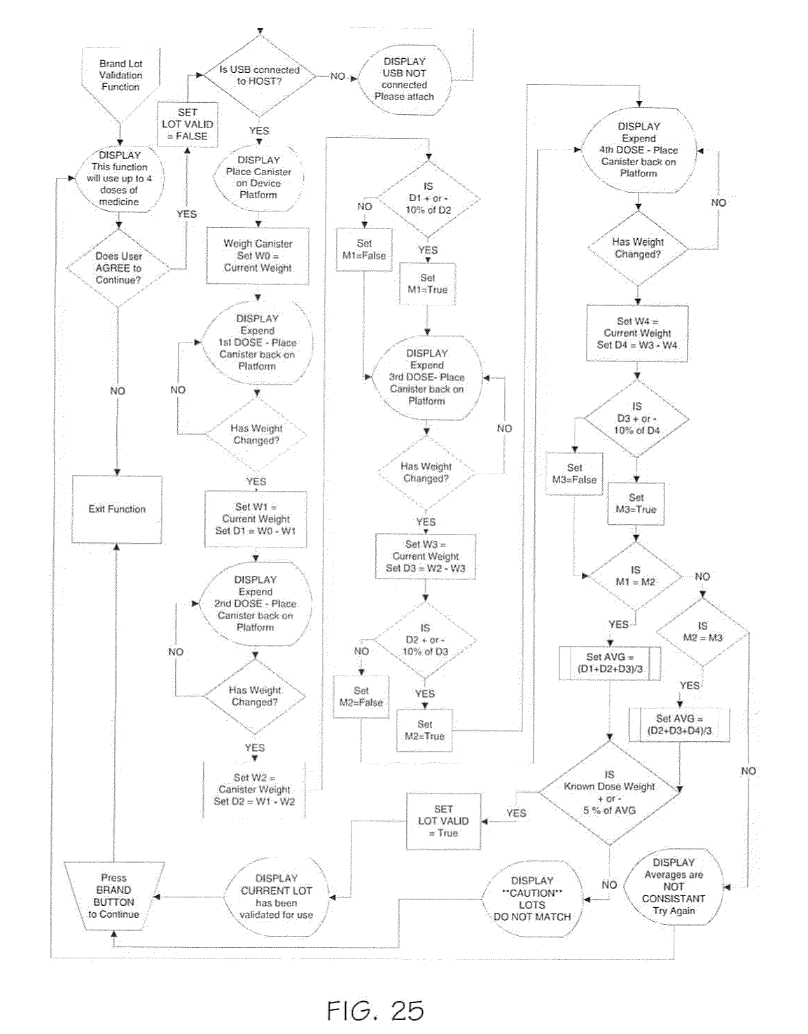

The client software also allows for the validation of medication LOTS. This feature ensures that the medicine being weighed is within the expected specifications. From the client software, select the Brand LOT Function. The device is attached to the client computer via the USB cable and the new MDI to be validated is placed onto the device platform. The on screen instructions are then followed, expending one dose at a time until the function is completed. The client software will confirm or reject the LOT as being within the expected tolerance as demonstrated in FIG. 25.

The USB Interface port 41 is used to upload new Brand information to device. It is located on the right side of the device and connects to the Client PC via the USB cable. The device drivers must be loaded onto the Client PC prior to connecting the device to the PC. The drivers are downloaded from a proprietary website or loaded using the CD-ROM included with the original purchase. The client software (Synchronize Brand Tab) displays the MDI brands available for transfer on the PC on the left side of the screen (Local Brands) and the existing brands already loaded on the device (Device Brands) on the right side of the screen. Highlighting the brand number on the Device Brands will show complete information about the medication stored in the brand locations (i.e. Brand 1 or Brand 2) in the Brand View window. The brand is highlighted for transfer to the device from the Local Brand list and transferred once the radio button of the brand location to be replaced is selected and confirmed. After the transfer is complete, a confirmation message will appear on the client PC. After all brands have been transferred to the device, the Brand Select button on the device may be used to select the brand to be measured.

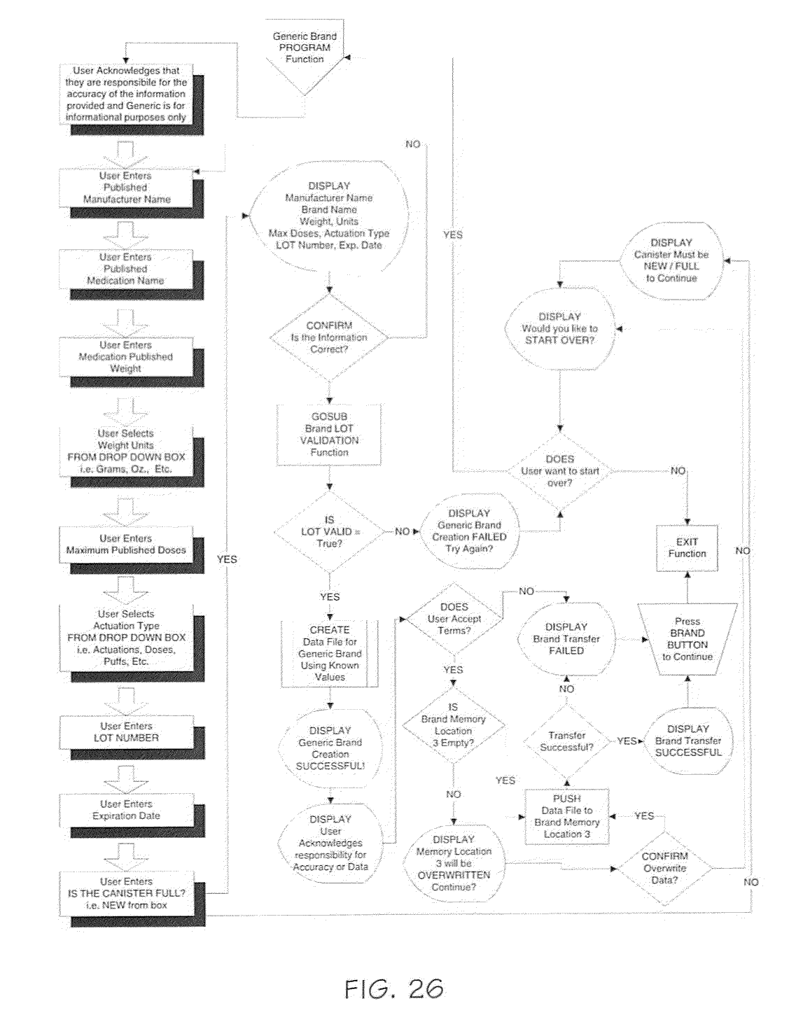

The USB Interface port 41 is also used to upload Generic information to the device. The drivers are downloaded from a proprietary website or loaded using the CD-ROM included with the original purchase. The user enters information regarding the published manufacturer name, medication name, published weight of medication and maximum published doses in order to create a data file for a generic brand as shown in FIG. 26.

The SIM data card reader should have an attached LCD screen. This screen is to give out calculated information such as: number of dosages left within the inhaler, the type of inhaler being tracked, the company logo and version number. It can also display the user information and future data such as dosages to be given per day, timing of dosages and user profile information, for example. The initial startup screen will have the company logo, greeting messages and error messages. These greeting messages could be the user's name, or a simple initiating startup message. The error messages will be the detection of the failure of the data card, USB port, or transfer data failures. If the card tests out correctly the device scale will now go into operational mode and data will now be viewable. A secondary screen is the first screen of the operational mode view. It will display the name of the manufacturer of the inhaler, the specific name of the inhaler and the weight of the inhaler along with its calculated number of remaining doses.

The data output screen displays the calculated values of the doses used and doses left within the inhaler. The display is calculated using the equations to determine the remaining amount of medication within the inhaler. For simplicity of use, this device may exhibit on the display the doses remaining rounded up or down to the nearest (quarter) ¼ number (i.e., ¼, ½, ¾)or fractional values. This provides the user with a value that is easy to interpret rather than providing decimal values. However, the circuitry also calculates to the 10ths or 100ths decimal point since the device is accurate enough to measure and display such precise differences.

It is therefore to be understood that even though numerous characteristics and advantages of the embodiments shown and described have been set forth in the foregoing description, together with the details of the structure and function of the embodiments, the disclosure is illustrative only, and changes may be made within the principles of the embodiments to the full extent indicated by the broad general meaning of the terms and reasonable equivalents thereof.

I claim:

1. A medication dosage measuring and display device, comprising;
a scale unit with a weigh pan housed within a base member, said scale unit operative to accept input and provide output based on load cell members;
means for powering said device;
a display unit associated with said scale unit; and
means for converting weight data from said scale unit to dosage information to be displayed on said display unit.

2. The device according to claim 1 wherein said device is color coded with a matching brand of medication.

3. The device according to claim 1 wherein said output is converted to dosage information for a selected brand of medication.

4. The device according to claim 1 wherein said converting means includes data values programmed into said device using a software program with or without a graphical user interface.

5. The device according to claim 1 wherein said device includes a data member insertable into a port on said device.

6. The device according to claim 1 wherein said display unit includes a visual or audible indicator of fractional doses remaining.

7. A dosage measuring and display device comprising a scale unit having a base plate, a cover plate and a recloseable lid member; said base plate and said cover plate are joined along a common edge and house at least one battery and load cells; said unit having a dosage level display screen and a USB port connected to a target computer.

8. The device according to claim 7 wherein said USB port uploads all of the calibration information along with user and medical information to an internal non-volatile memory of said device.

9. The device according to claim 7 wherein an erasable/reprogrammable memory chip is integrated on a circuit board of said device.

10. The device according to claim 7 wherein said unit includes a data card reader port.

11. Apparatus for measuring and displaying the number of doses remaining in a metered-dose inhaler comprising:
a hand-held unit having a weigh scale with electronic sensing means and a display screen;
first means for storing the gross weight of said inhaler in said sensing means;
second means for storing the original number of doses contained within said inhaler in said sensing means;
said sensing means being operative to record the weight of said inhaler after one or more doses have been expelled from said inhaler and subtracting said measured weight from said gross weight to determine the net weight of the contents of said inhaler;
and means for dividing the net weight of said contents by the per dose weight and displaying the resultant number of doses remaining in said inhaler on said display screen.

12. The apparatus according to claim 11 wherein said scale includes a serial port connector.

13. The apparatus according to claim 11 wherein said unit includes fourth means for selecting a brand of medicament including a generic brand and validation of said brand.

14. The apparatus according to claim 11 wherein said scale includes a data card port for accessing stored information on a data card.

15. A method of determining the number of doses contained in a hand-held metered-dose inhaler comprising the steps of:
storing the tare weight of said metered-dose inhaler;
storing the gross weight of said metered-dose inhaler and subtracting said tare weight from said gross weight to determine the net weight of the contents of said inhaler;
placing the metered-dose inhaler on a weigh sale and recording its actual weight after one or more doses have been expelled; and
converting the net weight of said contents into the doses remaining in said medicated-dose inhaler.

16. The method according to claim 15 including the step of displaying on a screen associated with said weigh scale, the number of doses remaining in said inhaler.

17. The method according to claim 15 wherein medication data is transferred to and from said device and allows for the configuration of multiple medication brands for multiple users on the same device scale.

18. The method according to claim 15 including the step of providing color coded references to indicate the percentage of doses remaining in said inhaler on said screen.

19. The method according to claim 15 wherein said method includes validation of expected specifications of a selected medication.

20. The method according to claim 15 wherein a generic data file may be created by entering information regarding the published manufacturer name, medication name, published weight of medication and maximum published doses.

21. The method according to claim 15 including the step of providing an audible alert when the number of doses remaining reaches a predetermined level.

22. A measuring and display system for use in displaying data related to medicinal dosing, the display system having a weight system to determine the amount of therapeutic substance present in a storage container and a display board adapted to display information generated from said weight system.

23. The measuring and display system according to claim 22 wherein said weight system includes a signal mode for detecting an event indicative of weight being placed on the weight system.

24. The measuring and display system according to claim 22 wherein said display board being operative to display user data history and medication compliance.

25. The measuring and display system according to claim 23 wherein said signal mode transmits a signal resulting in conversion to preselected data.

26. A method of measuring dosage levels in a pressurized container, having a scale member with a display feature and power unit, the steps comprising;
a first event detecting the weight of said pressurized container when placed on the said scale member, a second event whereby a load cell system sends a signal to a microprocessor based on said first event;
a third event based on application of an equation to the second event resulting in data conversion; and
a fourth event displaying the converted data on said data display.

27. The method according to claim 26 wherein said scale member includes a serial port connector.
